(19) United States
(12) Patent Application Publication
(10) Pub. No.: US 2004/0190628 A1
(43) Pub. Date: Sep. 30, 2004

(54) Video information decoding apparatus and method

(76) Inventor: Haruyoshi Murayama, Kanagawa (JP)

Correspondence Address: William S. Frommer, Esq., FROMMER LAWRENCE & HAUG LLP, 745 Fifth Avenue, New York, NY, 10151, US

(21) Appl. No.: 10/756,567

(22) Filed: Jan. 13, 2004

(30) Foreign Application Priority Data
Jan. 14, 2003 (JP) 2003-006309

(51) Int. Cl. H04N 7/12

(52) U.S. Cl. 375/240.25; 375/240.12; 375/240.01

(57) ABSTRACT

An output image selector (17) compares STC of a display unit (15) and PTS of a frame, and states selection information indicating whether a frame nearest to later STC than PTS is to be selected at present in a memory area where the frame is stored so that the memory area is selected as an extraction destination. The display unit (15) extract frames from memories (14) on the basis of the selection information, and combine them together. A decoder (13) judges, according to the selection information, whether the memory area is to be liberated or held. Thus, a plurality of streams can be displayed with synchronization of streams with each other, not depending upon a difference in frame rate from one stream to another.

### BACKGROUND OF THE INVENTION

1. Field of the Invention

The present invention generally relates to a video information decoding apparatus and method, and more particularly to a video information decoding apparatus and method, suitable for use to send video data from a sending side to a receiving side via a transmission channel as in a teleconference system, TV telephone system, broadcasting system, multimedia data base searching system or the like, and make real-time reproduction (streaming) of the received video data at the receiving side.

This application claims the priority of the Japanese Patent Application No. 2003-006309 filed on Jan. 14, 2003, the entirety of which is incorporated by reference herein.

2. Description of the Related Art

Recently, there have become prevalent in the information distribution between a broadcast station and general households an image information converting method and apparatus, capable of achieving a high-efficiency information transmission and storage using the redundancy peculiar to the image information in dealing with the image information as digital data.

The above image information converter adopts a technique for compressing image data by the orthogonal transformation such as the discrete cosine transform or the like and the motion compensation, for example. Especially, the image coding method standardized in the MPEG (Moving Picture Experts Group) is defined as a multi-purpose image coding method in ISO/IEC 13818 and supposed to continuously be used in a wide range of applications from a professional application to a consumer application.

In the image information converter to convert image data by the motion compensation and discrete cosine transform as in the MPEG; it is judged which is to be used as a coded unit of each macro block image data, intra-image coded image (will be referred to as “intra coded image” hereunder) or inter-image coded image (will be referred to as “inter coded image” hereunder) and which is to be used as a reference image frame, forward predictive-coded image, backward predictive-coded image or bilateral predictive-coded image.

Along with the recent prevalence of the inter-network data transmission as in the Internet and the portable digital assistance capable of dealing with multimedia data, integrated multimedia coding techniques for the data transmission and multimedia-data dealing are defined as MPEG-4 standard in ISO/IEC 14496. Basically adopting tools used in MPEG-1, MPEG-2 and ITU-T H.263, the MPEG-4 permits to encode three-dimensional space information to be sent for each object such as a person, building and the like in a space individually, to thereby improve the efficiency of coding and enable the treatment and edition of each object.

The MPEG-4 is to display each picture obtained by each predictive coding as video data on a display or the like, and send the picture to a receiving side via a transmission channel such as a teleconference system, TV telephone system, broadcasting system, multimedia data base searching system or a network such as the so-called Internet or the like and make real-time reproduction (will be referred to as “streaming” hereunder) of the picture at the receiving side.

The coded bit stream received at the receiving side has been undergone an error correction, decoding and the like. However, a packet loss, data error or frame rate variation caused by traffic on a transmission channel is not avoidable. Especially, in case the code beat stream includes multiple streams each consisting of a plurality of images, a congestion of the network or a difference in capability between communication apparatus will possibly cause a frame rate variation. Also, the frame rate varies from one apparatus to another in some cases.

For displaying, on a display unit, multimedia data different in frame rate from each other as one image data, a decoder capable of receive a plurality of multimedia data selects a frame rate of image data according to the frame rate of the display unit to absorb a frame rate different from one stream or apparatus to another, and thus displays the multimedia data on the same display unit synchronously with each other, as shown in FIG. 1.

For example, Aₒ, Bₒ and Cₒ. are displayed on the display unit at times Tₒ and T₁, A₁, Bₒ and Cₒ are displayed at time T₂, A₁, B₁, and C₁ are displayed at time T₃, and A₂, B₁ and C₁ are displayed at times T₄ and T₅, whereby the plurality of multimedia data is displayed synchronously with each other according to the displayable frame of a stream and display unit.

Also, to reproduce a plurality of data streams on one display unit synchronously with each other, there was proposed a technique for elimination of troubles likely to take place in synchronous display due to a difference in reference frequency between the data streams by determining a main one of the plurality of supplied data streams and decoding and reproducing other ones according to reference time information of the main stream (as in the Japanese Published Unexamined Application No. 2001-197048.

With the above-mentioned technique for reproducing a plurality of data streams synchronously, however, the more the data streams to be sent, the larger the number of patterns for selection of an image to be displayed is and the operation for displaying data streams different in frame rate from one another is more complicated. Also, there has been proposed a technique for improving the image quality of one frame by reducing the frame rate when the network is congested, with this technique, however, control for synchronous reproduction and display is difficult because the frame rate varies frequently. That is, with the conventional techniques for synchronous reproduction of a plurality of data stream, the data stream can hardly be made synchronous with each other without monitoring whether the network is congested and taking an instant action against the congestion, if any, to address the above frame rate variation.

Especially, on the assumption that with the MPEG-4 method for object coding, image data is divided for each of objects into different data streams for real-time reception and real-time reproduction (streaming), synchronization, for display, of multiple data streams sent at different frame rates depending upon the condition of the network is difficult, and non-synchronization between images displayed, for the above-mentioned selection and control of the display frame.

Furthermore, there have been proposed and available various types of display units such as a CRT display, LCD (liquid crystal display) and the like in the recent field of art and thus the display frame rate is different from one display unit to another. In addition, there has been proposed a technique for reducing the display rate for a lower power consumption of the display unit. With this technique, however, it is necessary to make synchronization between sent data streams as well as between a variation of display frame rate of the display unit itself and data streams to be displayed.

### OBJECT AND SUMMARY OF THE INVENTION

It is therefore an object of the present invention to overcome the above-mentioned drawbacks of the related art by providing an image signal decoding apparatus and method, capable of decoding a plurality of streams to combine the data together for display by synchronizing the data streams with each other without dependence upon any difference in frame rate between the data streams.

The above object can be attained by providing an image information decoder as an image signal output device which receives a plurality of coded image compression information and outputs the information as one image data, the apparatus including according to the present invention:

a dividing means for dividing the plurality of image compression information;

a decoding means for decoding each of the divided image compression information and extracting output time information indicating a time when image data obtained by the decoding is to be outputted;

a storage means for storing the image data and output time information;

a reference time information generating means for generating reference time information;

an output image selecting means for making a comparison between the reference time information and output time information and writing, to a storage means, selection information intended for selecting, as an extraction destination, an area where there is stored one, having an output time nearest to the reference time, of image data including earlier output time information than the reference time information; and

a displaying means for extracting image data according to the selection information recorded in the storage means and displaying the image data as one image data synchronously with the reference time.

In the displaying means in the above image information decoder, the number of display image frames per unit time is variable and the reference time information generating means can receive a signal indicative of the number of display image frames and vary the reference time information according to the signal.

Also, in the above image information decoder, the image compression information should preferably comply with the MPEG-4 standard, and PTS (presentation time stamp) is used as the output time information. In case the image compression information includes no PTS, the output time information may be calculated by the decoding means as a reciprocal number of the number of frames received per unit time.

Also, the above object can be attained by providing an image information decoding method as an image signal output method in which a plurality of coded image compression information is received and outputted as one image data, the method including, according to the present invention, the steps of:

dividing the plurality of image compression information;

decoding each of the divided image compression information and extracting output time information indicating a time when image data obtained by the decoding is to be outputted;

storing the image data and output time information;

generating reference time information;

making a comparison between the reference time information and output time information and writing, to a storage means, selection information intended for selecting, as an extraction destination, an area where there is stored one, having an output time nearest to the reference time, of image data including earlier output time information than the reference time information; and

extracting image data according to the selection information recorded in the storage means and displaying, on a displaying means, the image data as one image data synchronously with the reference time.

In the above image information decoding method, the number of display image frames per unit time, displayable on the displaying means, is variable, and a signal indicative of the number of display image frames is received in the reference time information generating step and the reference time information is varied according to the signal.

Also, in the above image information decoding method, the image compression information should preferably be in compliance with the MPEG-4 standard, and PTS (presentation time stamp) is used as the output time information. In case the image compression information includes no PTS, the output time information may be calculated in the decoding step as a reciprocal number of the number of frames received per unit time.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 explains display of multimedia data different in frame rate from each other as one image data in the conventional decoder;

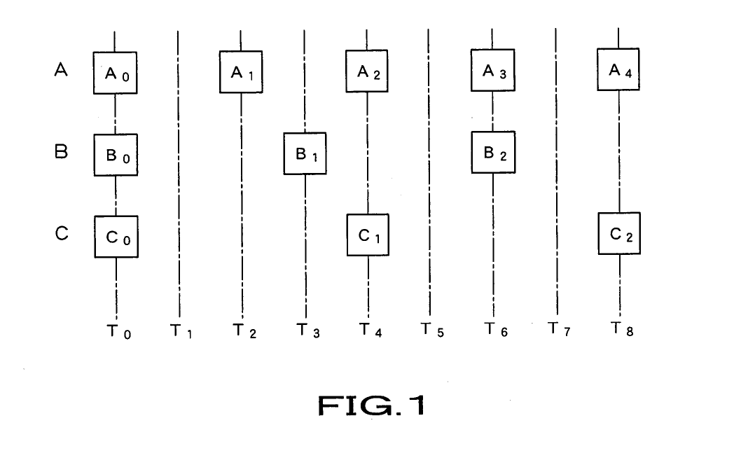

FIG. 2 explains an image information decoder as an embodiment of the present invention;

FIG. 3 explains image data and selection information, stored in a memory in the image information decoder in FIG. 2;

FIG. 4 explains the relation between the frame rate and STC of decoded image data output from the image information decoder; and

FIG. 5 explains an image information decoder as another embodiment of the present invention.

### DETAILED DESCRIPTION OF THE PREFERRED EMBODIMENTS

The image information decoder according to the present invention is to compress image data using an inter-frame correlation to provide image compression information. It reproduces video data for display on a display unit or the like. For sending a plurality of video data from a sending side to a receiving side via a transmission channel such as the so-called Internet as in a teleconference system, TV telephone system, broadcasting system or multimedia data base searching system and real-time reproduction (streaming) of the plurality of video data at the receiving side, the image information decoder can output the image data sent at different frame rates for simultaneous display on one monitor (display unit) by synchronizing the image data with each other.

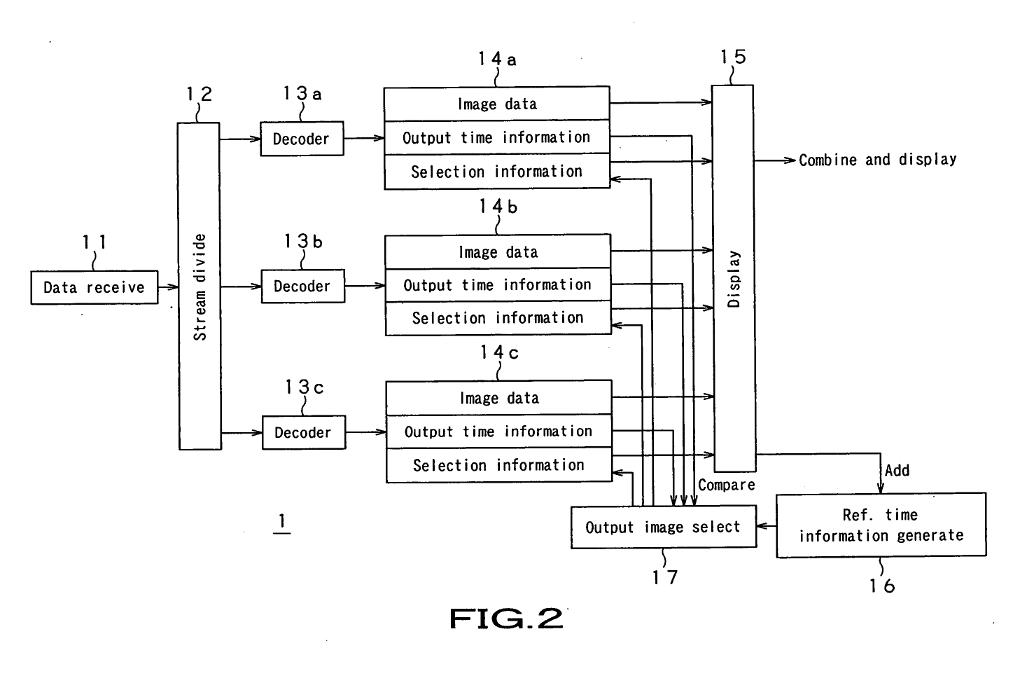

The present invention will be described in detail below concerning the embodiments thereof with reference to the accompanying drawings. FIG. 2 shows an image information decoder as a first embodiment of the present invention. The image information decoder is to decode input image data (image compression information) having been coded by an external image signal processor in the form of PES (packetized elementary stream). The embodiment is an application of the present invention to a decoder complying with the MPEG-4 standard. The first embodiment will be described on the assumption that an external system stream carries three types of data including streaming data A, B and C. Actually, however, the number of data streams is not limited to three.

To receive and decode external streaming data, the image information decoder, generally indicated with a reference number 1, includes a data reception unit 11 to receive a plurality of external streaming data, a stream division unit 12 to divide the received plurality of streaming data, decoders 13a, 13b and 13c to decode the divided streaming data, and memories 14a, 14b and 14c to provisionally store the decoded image data frame by frame before outputting, as shown in FIG. 2. Also, to output the decoded image data, the image information decoder 1 includes a display unit 15, a reference time information generator 16 to generate time information as a reference for determining a display frame rate for the display unit 15, and an output image selector 17 to designate output times for frames stored in the memories 14.

The data reception unit 11 receives the PES-formed streaming data sent from an external network such as the so-called Internet, and supplies the data to the stream division unit 12. The stream division unit 12 divides the streaming data, and supplies the divided data to the corresponding decoders 13, respectively. For example, the streaming data A, B and C are supplied to the decoders 13a, 13b and 13c, respectively.

The decoders 13a, 13b and 13c decode the corresponding streaming data, and supply the decoded image data frame by frame to the corresponding memories 14, respectively, and also information on times the frames are to be outputted (will be referred to as “output time information” hereunder) to the memories 14, respectively. PTS (presentation time stamp) included in PES is used as the output time information. However, in case the data includes no PTS, the output time information is calculated by the decoders 13. More specifically, the decoders 13 calculate reciprocal numbers of frame rate counts, add them together, and supply the results of addition as output time information to the memory 14.

Similarly to the decoders 13, the memory 14 is provided for each of the streaming data. Each of the memories 14 provisionally stores image data decoded by each decoder 13 and output time information for the image data (frame). Also, each of the memories 14 has stated therein, in association with stored image data for one frame, information indicating whether a memory area where the frame is stored is to be held or liberated. The information is stated by the output information selector 17 which will be described in detail later. The memories 14 will be described in detail later.

The display unit 15 displays image data read from the memories 14. Actually, the display unit 15 has a function to extract image data to be outputted at a due time from each of frames provisionally stored in the memories 14, a finction to combine the extracted image data synchronously, and a function to display the combined image data. Also, the display unit 15 informs the reference output information generator 16 of a display frame rate (reciprocal number of a predetermined display rate) each time it displays image data at the display rate.

The display unit 15 performs the data extraction finction and the function of synchronizing the extracted image data synchronously to extract, for each streaming data, frames from the memoriesl4 on the basis of the selection information stated in the memories 14 by the output image selector 17, combines the extracted frames together and displays the combined frame as one image data.

The reference time information generator 16 generates reference time information, so-called STC (system time clock), based on which the display unit 15 operates for display of the data. The reference time information generator 16 includes a clock which counts an absolute time, and generates an STC for the display operation by adding the reciprocal number of display rate sent from the display unit 15 to a count in the clock. Thus, even of the display frame rate is varied, the STC can be varied correspondingly.

The output image selector 17 compares an STC generated by the reference time information generator 16 and PTS (a value calculated as a reciprocal of a frame count, if not available) of each of the image data stored in the memories 14 along with the image data decoded by the decoders 13, and states selection information, indicating whether a frame nearest to a later STC than PTS is to be selected at present, in a memory area where the frame is stored so that the storage unit 15 can select the memory area as an extraction destination.

With the above selection information, the decoders 13 judge, when storing the decoded image data into the memories 14, whether the memory area is to be liberated or held, that is, whether the image data can be written to the memory area. In case there is not available any writable memory area, the decoders 13 will not make any decoding operation.

Therefore, receiving streaming data, the image information decoder 1 constructed as above divides the stream received in the stream division unit 12, and sends the divided streams to the corresponding decoders 13a, 13b and 13c, respectively. Each of the decoders 13 having received the streaming data decodes the streaming data, and stores the decoded image data to the memory 14 frame by frame while writing output time information indicating a time the frame is to be outputted to the memory 14. The output image selector 17 compares STC and PTS of each frame, and states, in association with a frame, selection information indicating whether the data is to be selected as output frame into a memory area. The display unit 15 extracts, combines and displays the frames on the basis of the selection information.

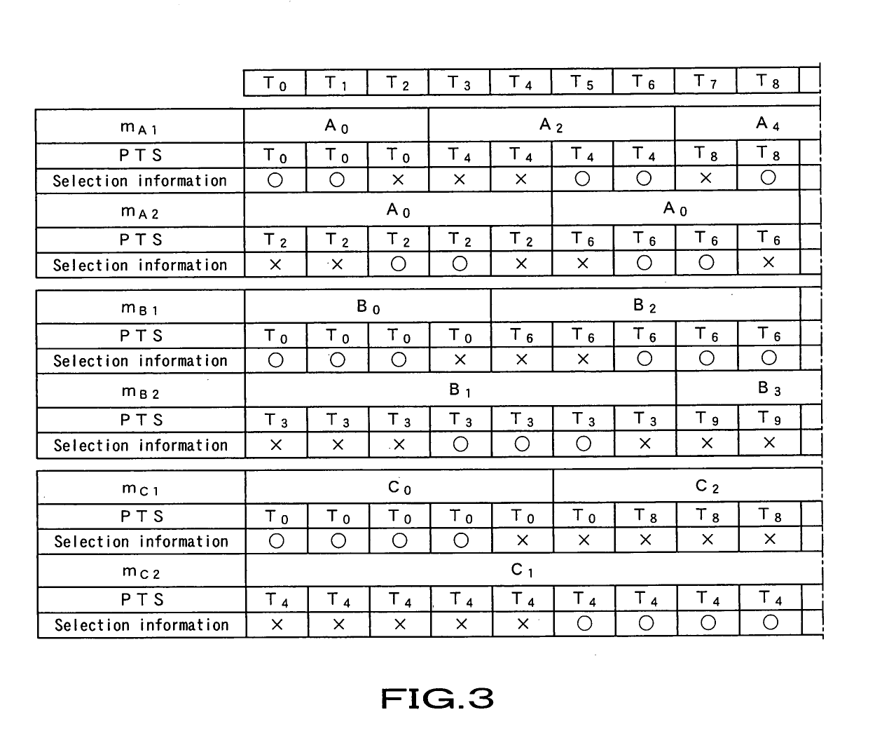

Next, the extraction by the display unit 15 of display frames from the memories 14 will be described in detail with reference to FIG. 3. According to this embodiment, the frame rate of the streaming data A is 15 frames/sec, that of the streaming data B is 10 frames/sec, that of the streaming data C is 7.5 frames/sec, and the display rate of the display unit 15 is 30 frames/sec.

As mentioned above, the memory 14 includes areas M_{A}, M_{B} and M_{C} for storing image data resulted from decoding of the streaming data as above. Each of these areas is divided into two areas m_{A1}, and m_{A2}. Image data for one frame can be stored in the area m_{A1}.

The memory 14 stores the decoded image data from the decoder 13 and output time information (PTS) incident to the image data. The area m_{A1}, stores PTS To of the Aₒ frame along with the Aₒ frame, and area m_{A2} stores PTS T₂ of the A₁ frame along with the A₁ frame.

Also, the memory 14 has stated therein by the output image selector 17 selection information for selecting, as an extraction destination, an memory area where there is stored a frame temporally nearest to a later STC than PTS so that the frame is outputted. That is, while the frame stored in the memory area is being used, there is stated a flag (indicated with a small circle “∘”) indicating that the area where the frame is stored is selected. When the frame is not used any longer, there is stated a flag (indicated with a sign “x”) indicating that the area where the frame is stored is not selected.

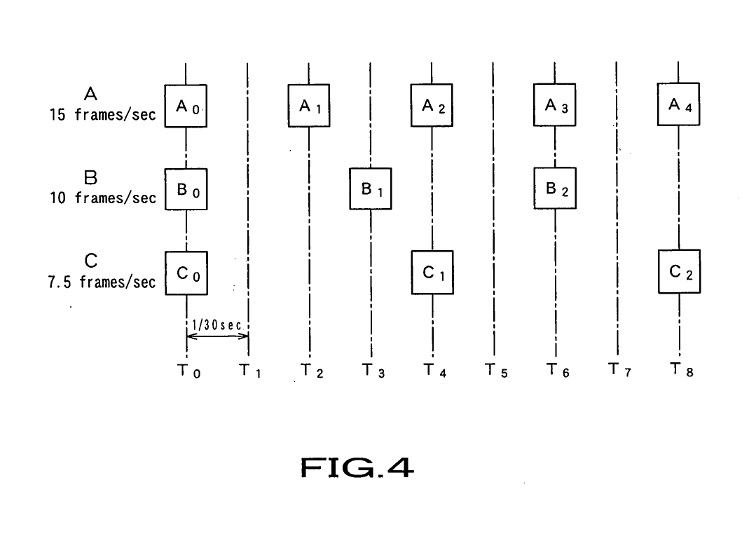

Therefore, when a frame is extracted on the basis of the selection information, the display unit 15 will continuously display the frame A₁ for the streaming data A while the STC of the display unit 15 counts T₂ and T₃, and the frame Bₒ for the streaming data B while the STC counts Tₒ, T₁ and T₂, as shown in FIG. 4. When the frame is not used any longer, the flag indicating that the area is not selected is stated by the output image selector 17. With this flag, the decoder 13 will write image data for next one frame to the area. “STC T₂→T₃, T₆→T₇” in the area m_{A1} and “STC T₄→T₅” in the area m_{A2} as shown in FIG. 3 correspond to the above operations.

As above, the output image selector 17 can compare STC of the display unit 15 and PTS as the output time information of each frame, and state selection information specifying an extraction-destination memory area along with the image data without the necessity of always monitoring any variation of the display rate of the display unit 15. Finally, the extraction of frames being done so that streaming data can be displayed on one screen with synchronization between the frame rate of the streaming data and display frame rate of the display unit 15 can be achieved by extracting image data according to the selection information in the memories 14 by means of the display unit 15. So the synchronous reproduction (streaming) of a plurality of streaming data can be performed more simply than ever.

Also, the storage by the decoders 13 of the display time information into the memories can be attained by adding PTS extracted from PES, or a value calculated as a sum of reciprocal numbers of frame rates. Thus, since STC can be managed easily in the display unit 15, the algorithm for implementation of the above may be simple.

By monitoring the frame rates of the streaming data by the decoders 13 and managing the reference time information for display on the display unit 15, it is made unnecessary to manage the frame rate of each streaming data in the output image selector 17 and display rate in the display unit 15. Even if the number of streaming data increases, the output image selector 17 has only to extract image data correspondingly to the selection information. Thus, the load to the output image selector 17 is small.

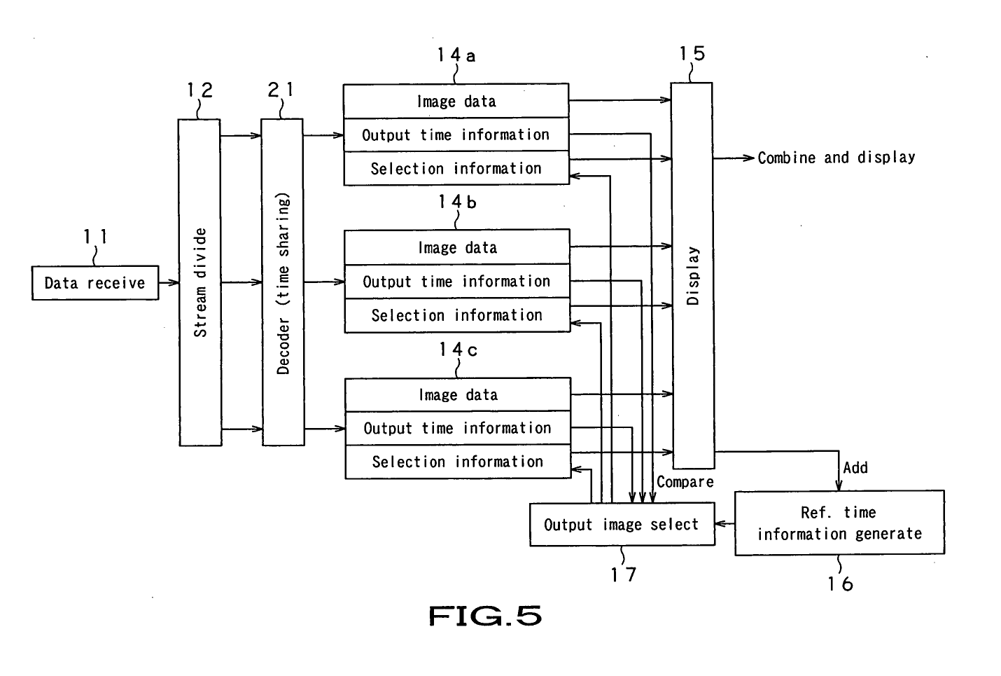

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims. For example, a plurality of streaming data may be decoded by a single decoder 21 as shown in FIG. 5 showing another embodiment of the image information decoder according to the present invention. In this embodiment, the decoder 21 makes time-sharing decoding of each of divided streaming data, and stores decoded image data sequentially into the memory corresponding to the streaming data starting with the first decoded one. The selection information statement and selection information-based frame extraction can be done as in the image information decoder 1 shown in FIG. 2.

As having been described in the foregoing, in the image information decoder according to the present invention, the output image selecting means compares reference time information and output time information and states, in the storage means, selection information intended for selecting, as an extraction destination, an area where one, having an output time nearest to the reference time, of image data including earlier output time information than the reference time information, and the displaying means combines the streams for synchronous display without dependence upon any difference in frame rate between the data streams by extracting output image data on the basis of the selection information.

Also, in the image information method according to the present invention, reference time information and output time information are compared with each other, and selection information intended for selecting, as an extraction destination, an area where one, having an output time nearest to the reference time, of image data including earlier output time information than the reference time information, is stated in the storage means, and the streams are combined together for synchronous display without dependence upon any difference in frame rate between the data streams by extracting output image data on the basis of the selection information.

What is claimed is:

1. An image information decoder which receives a plurality of coded image compression information and outputs the information as one image data, the apparatus comprising:
a dividing means for dividing the plurality of image compression information;
a decoding means for decoding each of the divided image compression information and extracting output time information indicating a time when image data obtained by the decoding is to be outputted;
a storage means for storing the image data and output time information;
a reference time information generating means for generating reference time information;
an output image selecting means for making a comparison between the reference time information and output time information and writing, to a storage means, selection information intended for selecting, as an extraction destination, an area where there is stored one, having an output time nearest to the reference time, of image data including earlier output time information than the reference time information; and
a displaying means for extracting image data according to the selection information recorded in the storage means and displaying the image data as one image data synchronously with the reference time.

2. The apparatus as set forth in claim 1, wherein:
the displaying means has a variable number of display image frames per unit time; and
the reference time information generating means receives a signal indicative of the number of display image frames and varies the reference time information according to the signal.

3. The apparatus as set forth in claim 1, wherein the image compression information complies with the MPEG-4 standard.

4. The apparatus as set forth in claim 3, wherein the output time information is PTS (presentation time stamp).

5. The apparatus as set forth in claim 1, wherein the output time information is calculated by the decoding means as a reciprocal number of the number of frames received per unit time.

6. An image information decoding method in which a plurality of coded image compression information is received and outputted as one image data, the method comprising the steps of:
dividing the plurality of image compression information;
decoding each of the divided image compression information and extracting output time information indicating a time when image data obtained by the decoding is to be outputted;
storing the image data and output time information;
generating reference time information;
making a comparison between the reference time information and output time information and writing, to a storage means, selection information intended for selecting, as an extraction destination, an area where there is stored one, having an output time nearest to the reference time, of image data including earlier output time information than the reference time information; and
extracting image data according to the selection information recorded in the storage means and displaying, on a displaying means, the image data as one image data synchronously with the reference time.

7. The method as set forth in claim 6, wherein:
in the displaying step, the number of display image frames per unit time, displayable on the displaying means, is variable; and
in the reference time information generating step, a signal indicative of the number of display image frames is received and the reference time information is varied according to the signal.

8. The method as set forth in claim 6, wherein the image compression information complies with the MPEG-4 standard.

9. The method as set forth in claim 8, wherein the output time information is PTS (presentation time stamp).

10. The method as set forth in claim 6, wherein the output time information is calculated by the decoding means as a reciprocal number of the number of frames received per unit time.
